(19) United States
(12) Patent Application Publication
(10) Pub. No.: US 2018/0029515 A1
(43) Pub. Date: Feb. 1, 2018

(54) TAILGATE WITH INTEGRATED RAMPS

(71) Applicant: FORD GLOBAL TECHNOLOGIES, LLC, Dearborn, MI (US)

(72) Inventors: Travis Justin Raines, Grosse Ile, MI (US); Pattrick Loew, Dearborn, MI (US)

(21) Appl. No.: 15/225,467

(22) Filed: Aug. 1, 2016

(51) Int. Cl. B60P 1/43; B62D 33/027

(52) U.S. Cl. CPC B60P 1/435; B62D 33/0273

(57) ABSTRACT

A tailgate assembly for a vehicle includes a pair of hingedly connected panels and at least one extendable ramp member held within a one of the pair of hingedly connected panels. The hingedly connected panels are configured to pivot between a substantially parallel stowed configuration defining a tailgate structure and an opened deployed orientation for use as a portion of a ramp.

### TECHNICAL FIELD

This document relates generally to the motor vehicle field and, more particularly, to a vehicle tailgate assembly configurable as a ramp.

### BACKGROUND

For various reasons, it may be desirable to provide a ramp structure to improve ease of loading items into of a vehicle cargo area such as a truck bed, such as for loading a wheeled vehicle into a truck bed or for loading large items into the truck bed using a wheeled implement such as a dolly. Conventionally, such ramp structures are carried as separate items in the vehicle cargo area. This reduces the amount of available cargo-holding space in the cargo area.

Accordingly, a need is identified for a vehicle ramp structure that can be easily stowed when not in use so as not to occupy otherwise usable cargo area storage space, but which can be rapidly and easily deployed from the stowed configuration for use. To address this need, a vehicle tailgate structure is described including deployable ramp members.

### SUMMARY

In accordance with the purposes and benefits described herein, a tailgate assembly for a vehicle includes a pair of hingedly connected panels and at least one extendable ramp member held within a one of the pair of hingedly connected panels. The hingedly connected panels are configured to pivot between a substantially parallel stowed configuration defining a tailgate structure and an opened deployed orientation for use as a portion of a ramp.

The hingedly connected panels are connected by at least one locking hinge. In embodiments, the at least one locking hinge is a three-locking-position hinge including a first locking position at 180 degrees rotation from the substantially parallel tailgate configuration and a second locking position whereby a one of the hingedly connected panels is held on a plane defining an included angle to the other of the hingedly connected panels held on a substantially horizontal plane.

The at least one extendable ramp member is configured to slidably translate between a stowed position within the one of the pair of hingedly connected panels and a deployed position for use as a ramp. In embodiments, the at least one extendable ramp member is slidably held within a cooperating sleeve associated with the one of the pair of hingedly connected panels. In embodiments, the one of the hingedly connected panels includes a pair of extendable ramp members.

In the following description, there are shown and described several preferred embodiments of the vehicle tailgate assembly. As it should be realized, the arrangement is capable of other, different embodiments and its several details are capable of modification in various, obvious aspects all without departing from the tailgate assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle tailgate assembly and together with the description serve to explain certain principles thereof. In the drawing figures:

FIG. 1A is a top view of a tailgate assembly for a vehicle according to the present disclosure;

FIG. 1B is a side view of the tailgate assembly of FIG. 1A;

FIG. 2A shows a top view of the tailgate assembly of FIGS. 1A and 1B in a first deployed orientation;

FIG. 2B shows a side view of the tailgate assembly of FIGS. 1A and 1B in a first deployed orientation;

FIG. 2C shows an embodiment of a locking hinge assembly for the tailgate assembly of FIGS. 1A and 1B;

FIG. 3 shows side view of the tailgate assembly of FIGS. 1A and 1B in a second, ground-engaging deployed orientation;

FIG. 4 shows a cutaway view of the tailgate assembly of FIGS. 1A and 1B, including receivers for holding a pair of extendable ramp members and a retention mechanism for holding the extendable ramp members in place;

FIG. 5A shows an embodiment of a retention mechanism for the extendable ramp members of FIG. 4, the extendable ramp members being in the retracted position; and

FIG. 5B shows the extendable ramp members in the extended position.

Reference will now be made in detail to the present preferred embodiments of the vehicle tailgate structure, examples of which are illustrated in the accompanying drawing figures.

### DETAILED DESCRIPTION

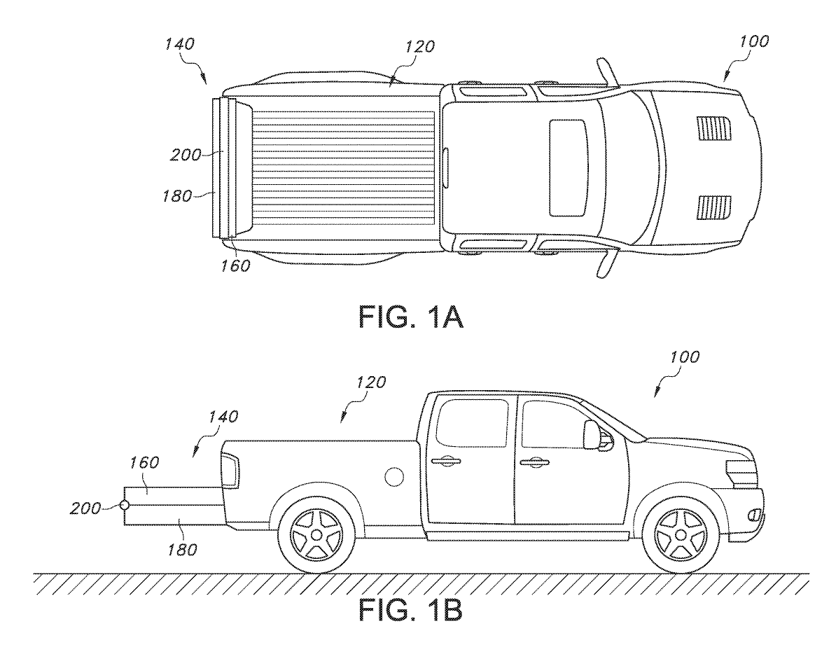

Reference is now made to FIGS. 1A and 1B, which illustrate a vehicle 100 including a cargo area 120 and a hingedly attached tailgate 140 configured for translating between the raised, generally vertical closed position of FIG. 1A and the lowered, generally horizontal open position of FIG. 1B. While the illustrated vehicle 100 is a pickup truck having a cargo area 120 defined by the truck bed, it will be appreciated that other vehicle types include such a tailgate or liftgate, for example sport-utility vehicles, station wagons, and others, and so the vehicle type and closure panel will not be construed as limiting. The tailgate 140 and cargo area 120 may include a variety of hinged, support, and latching devices which are well known in the art and which do not require extensive discussion herein.

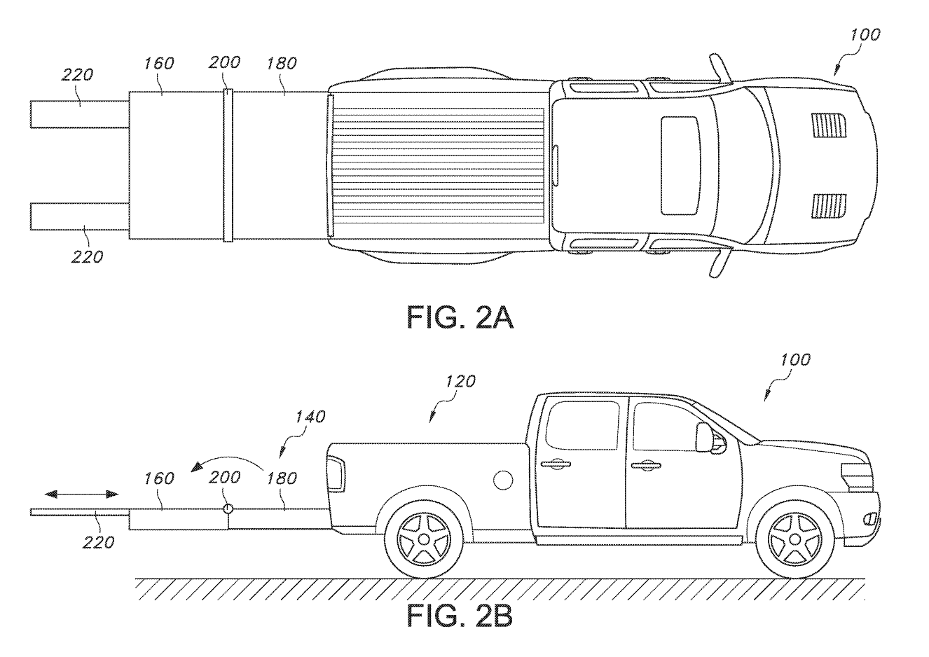

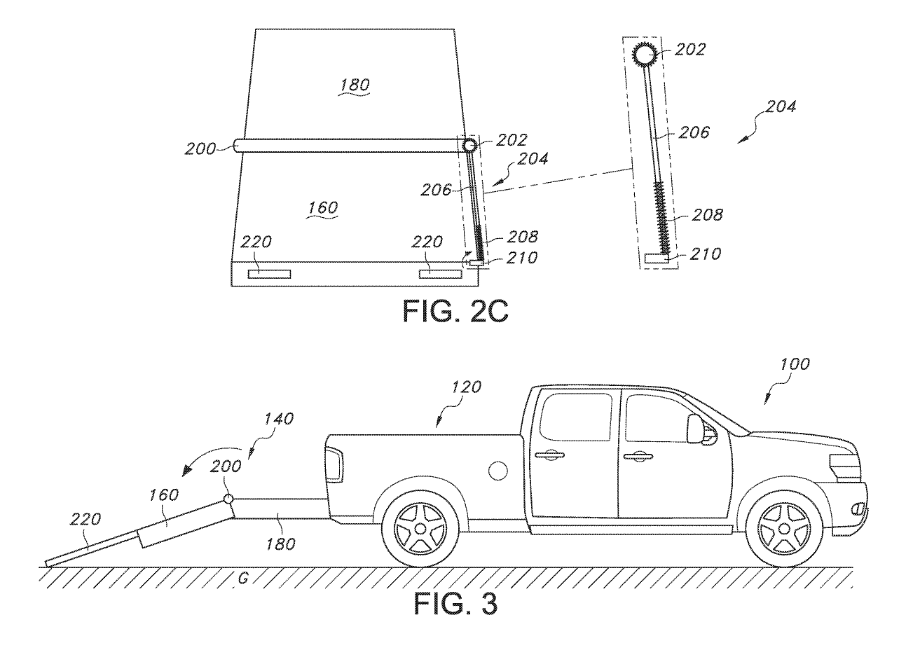

The tailgate 140 comprises a first panel 160 and a second panel 180, hingedly connected to define a folding tailgate 140 by at least one hinge structure 200. In the depicted embodiment, the second panel 180 is hingedly connected to a vehicle-rearmost portion of the vehicle cargo area 120 in a substantially conventional fashion. As will be described, the tailgate 140 is configured for translating between a folded, tailgate configuration (see FIGS. 1A-1B), a substantially horizontal orientation (see FIGS. 2A-2B), and an angled, ramp configuration (see FIG. 3). As will be appreciated, a single hinge structure 200 spanning a width dimension of the adjoining edges of tailgate panels 160, 180 may be provided as shown in the drawing figures. Alternatively, two or more such hinge structures 200 (embodiment not shown) may be provided.

To accomplish the above functions, use of a hinge 200 that is a locking hinge is contemplated. In the depicted embodiment, hinge 200 is a three-position locking hinge. As is known, a three-position locking hinge 200 is configured to provide a stowed locking position with tailgate panels 160, 180 stowed in the folded configuration shown in FIGS. 1A and 1B. With reference to FIGS. 2A and 2B, the three-position locking hinge 200 may also pivot along a 180 degree arc (see arrow) to a first deployed locking position providing the substantially horizontal orientation shown in the drawing figures. As will be appreciated, in this orientation, unfolded tailgate 140 provides a useful cargo area 120 extender structure. In turn, with reference to FIG. 3 the three-position locking hinge 200 may pivot further to a second deployed locking position providing an angled, ramp orientation whereby first panel 160 is held along an angled plane defining an acute angle to the substantially horizontal plane of second panel 180.

In more detail, FIG. 2C shows an embodiment of a locking hinge suitable for use in the presently disclosed device. As shown, a gear 202 is fixed to an end of the tailgate panel 180 near hinge 200. In turn, a lock bar assembly 204 is provided, configured for slidable movement within tailgate panel 160 for engaging the gear 202 teeth to lock the hinge 200 in a desired configuration. As shown, lock bar assembly 204 includes a lock bar 206 and a spring 208 mounted to bias the lock bar into locking contact with the gear 202. A squeeze handle 210 is provided for selectively causing the lock bar 206 to engage or release the gear 202 by way of a biasing force from spring 208. A groove lock (not visible in this view) may be provided whereby the lock bar assembly 204 can be selectively locked in the gear 202-released configuration and the gear-engaged configuration as desired.

As will be appreciated, by use of a gear 202, the number of locking positions possible for the locking hinge 200 is determined by the number of teeth on gear 202, and can vary as desired, for example, a three-position locking hinge as shown in the drawings and described herein or nearly infinite locking positions. The described mechanism is easily locked and unlocked, and being horizontally deployed provides a smooth hinge operation. The mechanism can be configured to automatically lock when the tailgate panels 160, 180 are in the folded configuration shown in FIGS. 1A and 1B, and once unlocked are gravity-assisted for a near-effortless transition to the fully opened configuration shown in FIGS. 2A and 2B, and therefrom to a ramp-down configuration described infra.

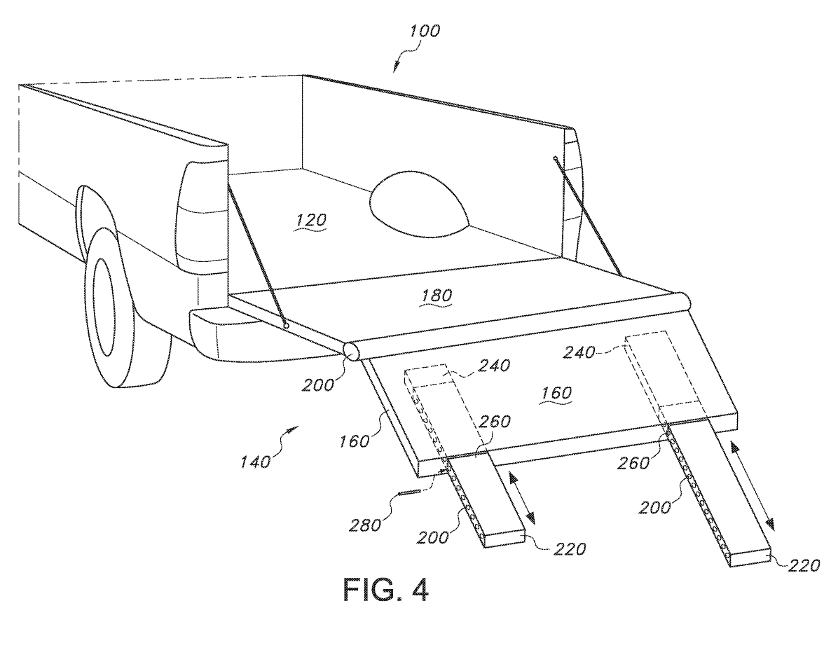

Tailgate panel 160 is provided with at least one ramp member 220 configured to be translated between a stowed position on or in the panel and a deployed position extending from the panel (see FIGS. 2A, 2B, 3). In the depicted embodiment, each ramp member 220 is slidingly received within a receiver 240 held within an interior of the panel 160 (see FIG. 4) and deploys via a slot 260. A latching mechanism may be provided for holding each ramp member 220 in the desired stowed or deployed position, such as a pin 280 for inserting into cooperating apertures 290. Alternatively, a single latching mechanism may be provided at a terminal end of each receiver 240 adjacent to slot 260, for retaining each ramp member 220 in a fully or partially stowed or deployed configuration.

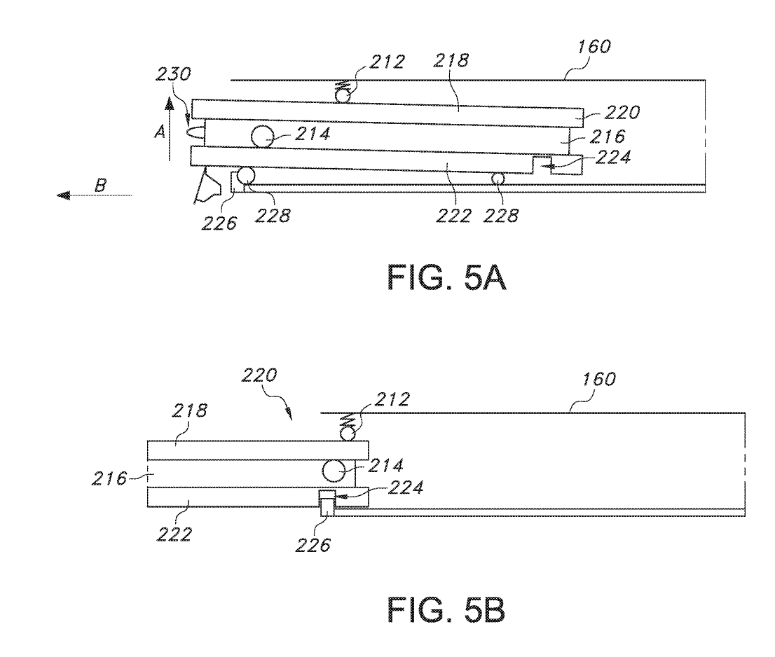

In one possible alternative embodiment of a latching mechanism as shown in FIGS. 5A and 5B, the tailgate panel 160 is provided with at least one spring roller 212 which imposes a biasing force upon a top surface of a ramp member 220, and at least one lateral roller 214 disposed within a ramp edge groove 216. Because of the groove 216, upper and lower rails 218, 222 are defined. A detent 224 is provided in an end of the lower rail 222. In turn, a cooperating lock key 226 is defined in a bottom edge of each slot 260. Bottom rollers 228 ensure that each ramp member 220 will roll smoothly while deploying and retracting. Each ramp member 220 further includes a handle 230 in a distal edge thereof farthest from the location of the detent 224.

When the ramp member 220 is in the retracted position, the at least one spring roller 212 imposes a biasing force on a top surface of the ramp member upper rail 218, and the lock key 226 engages a front edge of the ramp member to hold the ramp in an interior of the tailgate panel 160. To deploy the ramp member 220, a user need only grasp handle 230, lift upwardly (see arrow A) whereby the tailgate panel 160 clears the lock key 226 as shown in FIG. 5A, and pull the ramp 220 vehicle rearwardly (see arrow B). The at least one spring roller 212 will compress and the at least one lateral roller 214 will then contact a top surface of the lower rail 222, ensuring a smooth transition. When the ramp member 220 reaches the fully deployed position shown in FIG. 5B, the biasing force imposed by the spring roller 212 will cause the detent 224 to engage the lock key 226, thus locking the ramp member in the deployed configuration. To reverse the process, the user need only again lift the ramp member by way of handle 230 sufficiently for the detent 224 to clear the lock key 226, and push the ramp member vehicle-forwardly until the ramp member is fully within the tailgate panel 160 interior and the spring roller 212 biases the ramp member downwardly whereby the lock key 226 will retain the ramp member in the retracted position.

Of course, alternative embodiments for ramp members 220 associated with a tailgate panel 160 are contemplated. For example, the ramp members 220 may be held within receivers (embodiment not shown) molded or otherwise formed in a surface of the tailgate panel 160, and configured to be raised to a generally vertical orientation and then to be lowered to the generally horizontal orientation shown in FIGS. 2A, 2B. An exemplary configuration of posts configured to be so stowed/deployed is shown in U.S. Pat. No. 7,090,276, the disclosure of which is incorporated herein by reference in its entirety, and this structure is contemplated for adaptation to ramp members 220 herein. The raising/lowering of the ramp members 220 may be accomplished by use of brackets including pivots. An example of such brackets is disclosed in U.S. Pat. No. 9,302,719. Any number of retainer mechanisms may be used to secure the ramp members 220 in a desired orientation, including without intending any limitation pins, clips, dogs, and other retainers.

The ramp members 220 may be held in the suitably configured and dimensioned receivers by a number of mechanisms. The receivers may be dimensioned to hold the ramp members 220 by a friction or interference fit. Alternatively or in addition, various clips (not shown) may be provided to hold or assist in holding the various components in the receivers. Still further, the ramp members 220 may be configured for removal from the tailgate panel 160 and insertion into dedicated brackets or sleeves 240 as described above, with pins, clips, etc. provided to secure the posts in the brackets or sleeves. All such mechanisms are contemplated for use herein.

In use, the tailgate 140 is pivoted to the substantially horizontal, open configuration shown in FIG. 1B and the panels 160, 180 are unfolded to the substantially horizontal configuration shown in FIG. 2B. Ramp members 220 are extended (see FIGS. 2A, 2B). Next, tailgate panel 160 is pivoted to the angled orientation shown in FIG. 3, whereby ramp members 220 engage a ground surface G on which the vehicle 100 is resting. At that point, vehicles or other items may be loaded into the cargo area 120 of the vehicle 100.

Additional features may be included, such as deployable guard rails (not shown) extending from one or both of panels 160, 180, configured for extending from an interior of each panel and for pivoting upwardly for locking in a substantially upright orientation to serve as guard rails. Likewise, tailgate panel 160 may also include a retractable tailgate-mounted step assembly. A number of suitable step assemblies which deploy from tailgate structures are known in the art, such as those described in U.S. Pat. Nos. 6,918,624, 7,090,276, and 7,234,749, the disclosures of which are incorporated herein by reference.

The foregoing has been presented for purposes of illustration and description. It is not intended to be exhaustive or to limit the embodiments to the precise form disclosed. Obvious modifications and variations are possible in light of the above teachings. For example, rather than a pair of ramp members 220 as shown in the drawing figures, a single ramp panel extending across a significant portion of the tailgate panel 160 could be provided. As will be appreciated, such a wide ramp structure would provide convenience and utility in loading items into the cargo area 120 using wheeled implements such as dollies, in loading vehicles having fewer than four wheels such as motorcycles/bicycles, and the like. All such modifications and variations are within the scope of the appended claims when interpreted in accordance with the breadth to which they are fairly, legally and equitably entitled.

1. A tailgate assembly for a vehicle, comprising:
a pair of hingedly connected panels adapted to translate between a substantially vertical tailgate orientation, a substantially horizontal folded orientation, a substantially horizontal opened orientation, and an angled orientation; and
at least one extendable ramp member associated with a one of the pair of hingedly connected panels.

2. (canceled)

3. The tailgate assembly of claim 2, wherein the hingedly connected panels are connected by at least one locking hinge.

4. The tailgate assembly of claim 3, wherein the at least one locking hinge is a three-locking-position hinge.

5. The tailgate assembly of claim 4, wherein the at least one locking hinge includes a first locking position at 180 degrees rotation from the substantially parallel tailgate orientation.

6. The tailgate assembly of claim 4, wherein the at least one locking hinge includes a second locking position whereby a one of the hingedly connected panels is held on a plane defining an included angle to the other of the hingedly connected panels held on a substantially horizontal plane.

7. The tailgate assembly of claim 1, wherein the at least one extendable ramp member slidably translates between a stowed position within the one of the pair of hingedly connected panels and a deployed position.

8. The tailgate assembly of claim 7, wherein the at least one extendable ramp member is slidably held within a cooperating sleeve associated with the one of the pair of hingedly connected panels.

9. The tailgate assembly of claim 8, including a pair of extendable ramp members.

10. A vehicle including the tailgate assembly of claim 1.

11. A tailgate assembly for a vehicle, comprising:
a pair of hingedly connected panels adapted to translate between a substantially vertical tailgate orientation, a substantially horizontal folded orientation, a substantially horizontal opened orientation, and an angled orientation; and
a pair of extendable ramp members associated with a one of the pair of hingedly connected panels.

12. (canceled)

13. The tailgate assembly of claim 12, wherein the hingedly connected panels are connected by at least one locking hinge.

14. The tailgate assembly of claim 13, wherein the at least one locking hinge is a three-locking-position hinge.

15. The tailgate assembly of claim 14, wherein the at least one locking hinge includes a first locking position at 180 degrees rotation from the substantially parallel tailgate orientation.

16. The tailgate assembly of claim 14, wherein the at least one locking hinge includes a second locking position whereby a one of the hingedly connected panels is held on a plane defining an included angle to the other of the hingedly connected panels held on a substantially horizontal plane.

17. The tailgate assembly of claim 16, wherein the extendable ramp members each slidably translate between a stowed position within the one of the pair of hingedly connected panels and a deployed position.

18. The tailgate assembly of claim 17, wherein the extendable ramp members are each slidably held within a pair of cooperating sleeves associated with the one of the pair of hingedly connected panels.

19. A vehicle including the tailgate assembly of claim 11.

20. A tailgate assembly for a vehicle, comprising:
a pair of hingedly connected panels adapted to translate between a substantially vertical tailgate orientation, a substantially horizontal folded orientation, a substantially horizontal opened orientation, and an angled orientation;
a three-locking-position hinge connecting the pair of hingedly connected panels; and
a pair of extendable ramp members associated with a one of the pair of hingedly connected panels.
